(19) United States
(12) Patent Application Publication
(10) Pub. No.: US 2016/0217906 A1
(43) Pub. Date: Jul. 28, 2016

(54) COIL COMPONENT

(71) Applicants: Seung Wook PARK, Suwon-Si (KR); Kwang Mo KIM, Suwon-Si (KR)

(72) Inventors: Seung Wook PARK, Suwon-Si (KR); Kwang Mo KIM, Suwon-Si (KR)

(21) Appl. No.: 14/929,743

(22) Filed: Nov. 2, 2015

(30) Foreign Application Priority Data
Jan. 27, 2015 (KR) 10-2015-0012721

(51) Int. Cl. H01F 27/28

(52) U.S. Cl. CPC H01F 27/2804; H01F 2027/2809

(57) ABSTRACT

A coil component includes an insulating layer; and a coil conductor embedded in the insulating layer and having a chamfered surface. The chamfered surface is provided on both sides of a lower surface of the coil conductor.

### CROSS-REFERENCE TO RELATED APPLICATION

This application claims the benefit of priority to Korean Patent Application No. 10-2015-0012721, filed on Jan. 27, 2015 with the Korean Intellectual Property Office, the entirety of which is incorporated herein by reference.

### BACKGROUND

The present disclosure relates to a coil component, and more particularly, to a coil component having a structure capable of reducing parasitic capacitance.

Recently, electronic devices such as mobile phones, home appliances, personal computers (PCs), personal digital assistants (PDA), liquid crystal displays (LCDs), GPS navigation systems, and the like have gradually been digitalized, and speeds of the electronic devices have increased. Since these electronic devices are sensitive to outside stimuli, when small abnormal voltage and high frequency noise are introduced into internal circuits of the electronic devices, circuits may be damaged or signals may be distorted.

Switching voltages generated in the circuits, power noise included in power supply voltages, unnecessary electromagnetic signals, and electromagnetic noise may cause such abnormal voltages and noise. As a means for preventing the abnormal voltages and high frequency noise flowing into circuits, coil components have widely been used.

In particular, high speed interfaces such as a universal serial bus (USB) 2.0, a USB 3.0, a high-definition multimedia interface (HDMI), and the like have adopted a differential signal system transmitting a differential signal (a differential mode signal) using a pair of signal lines, unlike a general single-end transmission system. Thus, the differential signal transmission system uses a common mode filter (CMF) for removing common mode noise.

However, a variety of coil components including the common mode filter suffer from parasitic capacitance that occurs between coil conductors due to structural characteristics of the coil components. Because the parasitic capacitance reduces impedance of the common mode filter, a solution for this problem has been required.

### SUMMARY

One aspect of the present disclosure may provide a coil component in which chamfering machining is performed on a lower surface of a coil conductor so that parasitic capacitance structurally occurring in the coil component may be reduced.

According to an aspect of the present disclosure, a coil component comprises an insulating layer; and a coil conductor embedded in the insulating layer and having a chamfered surface, wherein the chamfered surface is provided on both sides of a lower surface of the coil conductor.

The chamfered surface may have an inclined angle of 10° to 60°.

An upper surface of the coil conductor may have a convex shape.

A width of an upper surface of the coil conductor may be greater than that of the lower surface thereof.

According to another aspect of the present disclosure, a coil component comprises a magnetic substrate; and an insulating layer disposed on the magnetic substrate and having upper and lower coil conductors embedded therein, the upper and lower coil conductors being spaced apart from each other in a direction away from the magnetic substrate, wherein a chamfered surface is provided on both sides of a lower surface of at least one of the upper and lower coil conductors.

An upper surface of at least one of the upper and lower coil conductors may have a convex shape.

A width of an upper surface of at least one of the upper and lower coil conductors is greater than that of the lower surface thereof.

The insulating layer may include a first insulating layer covering the base layer; a second insulating layer covering the first insulating layer and containing the lower coil conductors; and a third insulating layer covering the second insulating layer and containing the upper coil conductors.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a cross-sectional view of a coil component including coil conductors according to a first exemplary embodiment in the present disclosure;

FIG. 2 is a cross-sectional view of a coil component including coil conductors according to a second exemplary embodiment in the present disclosure;

FIG. 3 is a cross-sectional view of a coil component including coil conductors according to a third exemplary embodiment in the present disclosure;

FIG. 4 is a cross-sectional view of a coil component including any one of the coil conductors according to the first to third exemplary embodiments in the present disclosure; and

FIG. 5 is an enlarged view of part A of FIG. 4.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

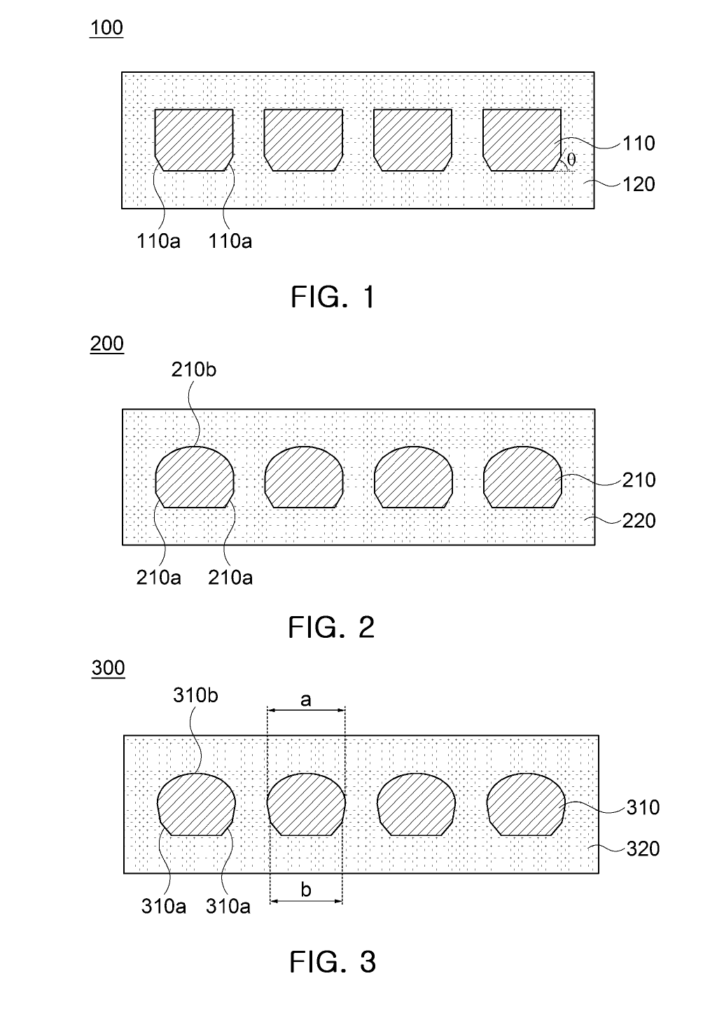

FIG. 1 is a cross-sectional view of a coil component including a coil conductor according to a first exemplary embodiment.

Referring to FIG. 1, a coil component 100, according to an exemplary embodiment, may include a base layer 120 and coil conductors 110 provided on the base layer 120.

The base layer 120 may serve to support the coil conductors 110. In addition, the base layer 120 may be formed to surround the coil conductors 110, thereby insulating the coil conductors 110 from each other and protecting the coil conductors 110 from external factors.

Thus, for a material of the base layer 120, a polymer resin having excellent insulation characteristics, thermal resistance, moisture resistance, and the like may be used. For example, as an optimal material forming the base layer 120, an epoxy resin, a phenol resin, a urethane resin, a silicon resin, a polyimide resin, and the like may be used.

The coil conductors 120, which are metal wires having a coil pattern wound on a surface of the base layer 120 in a spiral shape, may be formed of at least one selected from the group consisting of silver (Ag), palladium (Pd), aluminum (Al), nickel (Ni), titanium (Ti), gold (Au), copper (Cu), or platinum (Pt) having excellent electrical conductivity.

Although FIG. 1 illustrates the coil conductors 110 formed in a single layer, the coil conductors 110 may be formed in two or more layers. In this case, the coil conductors 110 in each layer may be disposed to be spaced apart from each other by a predetermined interval and may be interconnected through vias (not illustrated) to form a single coil. Alternatively, a primary coil and a secondary coil may be alternately disposed in a single layer, or may be disposed in respective layers.

As such, when the coil conductors 110 are formed in a plurality of layers, parasitic capacitance may occur between the coil conductor 110 formed in an upper layer and the coil conductor 110 formed in a lower layer. According to an exemplary embodiment, as a solution for reducing parasitic capacitance, lower surfaces of the coil conductors 110 which are in contact with the base layer 120 may be chamfered. That is, the coil conductors 110 included in the present exemplary embodiment may have chamfered surfaces 110a inclined at a predetermined angle (θ) or more in relation to the base surface by performing chamfering machining on both sides of the lower surfaces of the coil conductors 110.

Parasitic capacitance is inversely proportional to a distance between surfaces of two conductors facing each other. Therefore, since a distance between the coil conductors 110 disposed to face each other on the upper and lower layers is increased in the sides of the coil conductors 110 due to the chamfered surfaces 110a formed on the sides of the coil conductors 110, parasitic capacitance between the upper and lower layers may be reduced. For example, when the coil conductors 110 are disposed on the upper and lower layers to face each other, a distance between the lower surface of the coil conductor 110 positioned on the upper layer and the upper surface of the coil conductor 110 positioned on the lower layer may be gradually increased from the center of the lower surface of the coil conductor 110 positioned on the upper layer to the chamfered sides of the corresponding coil conductor 110.

In this case, as the angle of the chamfered surface 110a is increased, the distance between the coil conductors 110 positioned on different layers is further increased. Thus, in order to reduce parasitic capacitance, the angle (θ) of the chamfered surface 110a may be increased.

However, as the angle (θ) of the chamfered surface 110a is increased, the center of gravity of the coil conductor 110 may be moved upward, thereby increasing the possibility that defects such as pattern collapse occur. Thus, the angle (θ) of the chamfered surface 110a may be selected as an appropriate value in a range in which both the reduction of the parasitic capacitance and structural stability are guaranteed. Considering that a width of the coil conductor 110 required for 0403 size is about 6 μm, the angle of the chamfered surface 110a may be selected in a range of 10° to 60°.

FIG. 2 is a cross-sectional view of a coil component including coil conductors according to a second exemplary embodiment.

Referring to FIG. 2, in coil conductors 210 included in the present exemplary embodiment, lower surfaces of the coil conductors 210 which are in contact with a base layer 220 may have chamfered surfaces 210a formed on both sides of the lower surfaces thereof, and upper surfaces 210b thereof may be formed to be upwardly convex.

In this case, when the coil conductors 210 are disposed in upper and lower layers to face each other, a distance between a central point of the upper surface 210b of the coil conductor 210 positioned on the lower layer and the lower surface of the coil conductor 210 positioned on the upper layer become the shortest distance and is gradually increased toward both sides of the upper surface 210b of the coil conductor 210 positioned on the lower layer, whereby parasitic capacitance is reduced between the coil conductors 210 disposed in the upper and lower layers.

FIG. 3 is a cross-sectional view of a coil component including coil conductors according to a third exemplary embodiment.

Referring to FIG. 3, in coil conductors 310 included in the present exemplary embodiment, lower surfaces of the coil conductors 310 which are in contact with a base layer 320 may have chamfered surfaces 310a formed on both sides of the lower surfaces thereof, and upper surfaces 310b thereof may be formed to be upwardly convex.

In addition, a width a (upper width a) of the upper surface of the coil conductor 310 may be greater than a width b (lower width b) of the lower surface thereof. Here, the upper width a refers to a maximum straight line distance between both sides of the coil conductor 310, and the lower width b refers to a straight line distance between points at which both sides of the coil conductor 310 and the chamfered surfaces 310a meet.

As the upper width a of the coil conductor 310 is formed to be larger than the lower width b thereof, a cross-section of the coil conductor 310 according to the present exemplary embodiment may have a tapered shape of which a width is decreased toward a lower portion of the coil conductor 310. As a result, an interval between patterns of the coil conductors 310 may be increased, thereby decreasing parasitic capacitance.

In addition, as cross-sectional areas of surfaces of the conductors facing each other are small, parasitic capacitance between the conductors may be decreased. In a case in which the side surfaces of the coil conductors are formed to be inclined as in the present exemplary embodiment, since the cross-sectional area of the lower surface of the coil conductor is formed to be smaller than that of a coil conductor of which side surfaces are not inclined, parasitic capacitance between the upper and lower layers may be decreased.

Hereinafter, a coil component to which the coil conductors are applied will be described.

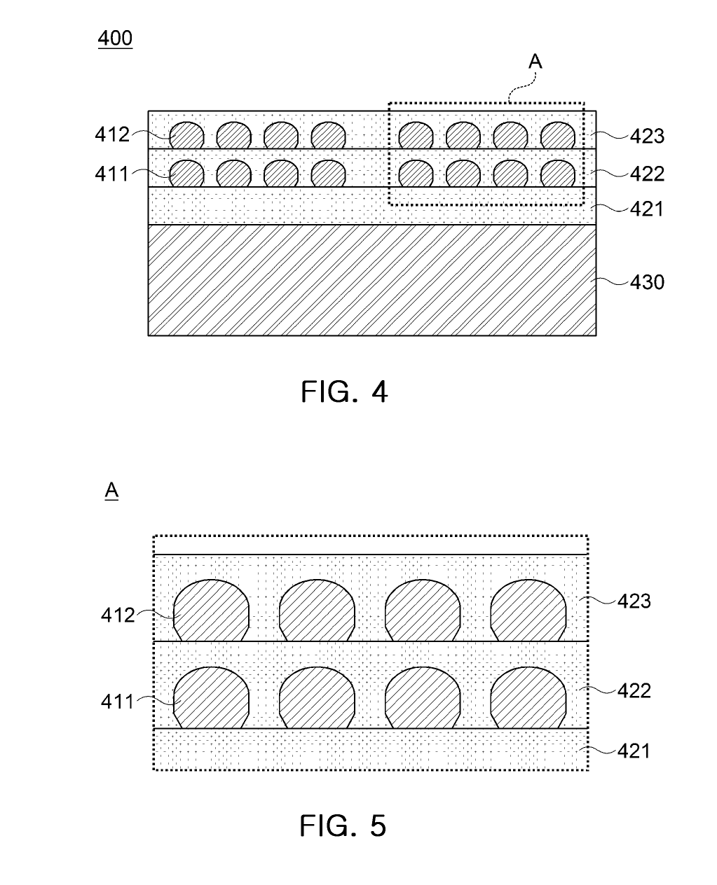

FIG. 4 is a cross-sectional view of a coil component including any one of the coil conductors according to the first to third exemplary embodiments and FIG. 5 is an enlarged view of part A of FIG. 4.

Referring to FIGS. 4 and 5, a coil component 400, according to the present exemplary embodiment, may include a magnetic substrate 430, and insulating layers 421, 422, and 423 provided on the magnetic substrate 430 and having coil conductors 411 and 412 embedded therein.

The magnetic substrate 430, which is a plate-shaped magnetic substance having an approximately rectangular shape, may be disposed in the lowest portion of the coil component 400 to support the insulating layers 421, 422, and 423. In addition, the magnetic substrate 430 may serve as a movement path of magnetic flux generated from the coil conductors 411 and 412 when current is applied to the coil conductors 411 and 412.

Therefore, the magnetic substrate 430 may be formed of any magnetic material as long as it may obtain predetermined inductance. For a material forming the magnetic substrate 430, an Ni based ferrite material containing Fe₂O₃ and NiO as main components, an Ni—Zn based ferrite material containing Fe₂O₃, NiO, and ZnO as main components, an Ni—Zn—Cu based ferrite material containing Fe₂O₃, NiO, ZnO, and CuO as main components, or the like, may be used.

The coil conductors 411 and 412 may include upper coil conductors 412 and lower coil conductors 411 spaced apart from each other by a predetermined interval and disposed on upper and lower layers to face each other. Here, the upper coil conductors 412 and the lower coil conductors 411 may be electromagnetically coupled to each other by forming separate coils, such as a primary coil and a secondary coil, respectively, or by forming a so-called simultaneous coil structure in which the primary and secondary coils are alternately disposed on a single layer.

Thus, the coil component 400, according to the present exemplary embodiments, may be operated as a common mode filter (CMF) in which when currents are applied to the upper coil conductors 412 and the lower coil conductors 411 in the same direction, the magnetic fluxes generated from the upper and lower coil conductors 412 and 411 are added to increase common mode impedance, and when currents are applied to the upper coil conductors 412 and the lower coil conductors 411 in opposing directions, the magnetic fluxes are offset to decrease differential mode impedance.

More specifically, the lower coil conductors 411 may be formed on a first insulating layer 421, which serves as a base layer, the upper coil conductors 412 may be formed on a second insulating layer 422 covering the lower coil conductors 411 by using the second insulating layer 422 as a base layer, and a third insulating layer 423 may cover the upper coil conductors 412. Thus, the upper coil conductors 412 and the lower coil conductors 411 may be embedded in the first to third insulating layers 421, 422, and 423.

Here, the first to third insulating layers 421, 422, and 423 may be formed of a polymer resin having excellent insulation characteristics, thermal resistance, moisture resistance, and the like, such as an epoxy resin, a phenol resin, a urethane resin, a silicon resin, or a polyimide resin.

In the coil component having the above-described structure, the upper coil conductors 412 and the lower coil conductors 411 may be any one selected from the group consisting of the coil conductors 110, 210, and 310 according to the first to third exemplary embodiments. As a result, the coil component according to the present exemplary embodiment may have various combinations of coil conductors.

As an example, in order to significantly increase a distance between the lower coil conductors 411 and lower surfaces of the upper coil conductors 412, the coil conductors according to the second or third exemplary embodiment having the upper surfaces having a convex shape may be used as the lower coil conductors 411. In addition, in order to significantly increase a distance between the upper coil conductors 412 and upper surfaces of the lower coil conductors 411, any one of the coil conductors according to the first to third exemplary embodiments in which both sides of the lower surfaces thereof are chamfered may be used as the upper coil conductors 412.

Although FIG. 5 illustrates a case in which the coil conductors according to the second exemplary embodiment are used as the upper coil conductors 412 and the lower coil conductors 411, the coil conductors according to the first exemplary embodiment may be used as the upper coil conductors 412 and the lower coil conductors 411, and the coil conductors according to the third exemplary embodiment may also be used as a structure for reducing parasitic capacitance between patterns together with parasitic capacitance between the upper and lower layers.

As set forth above, according to the exemplary embodiments, as an inter-layer distance and an inter-pattern distance between the coil conductors are increased, parasitic capacitance may be significantly reduced as compared to a coil component having a general structure according to the related art.

While exemplary embodiments have been shown and described above, it will be apparent to those skilled in the art that modifications and variations could be made without departing from the scope of the present invention as defined by the appended claims.

What is claimed is:

1. A coil component comprising:
an insulating layer; and
a coil conductor embedded in the insulating layer and having a chamfered surface,
wherein the chamfered surface is provided on both sides of a lower surface of the coil conductor.

2. The coil component of claim 1, wherein the chamfered surface has an inclined angle of 10° to 60°.

3. The coil component of claim 1, wherein an upper surface of the coil conductor has a convex shape.

4. The coil component of claim 1, wherein a width of an upper surface of the coil conductor is greater than that of the lower surface thereof.

5. A coil component comprising:
a magnetic substrate; and
an insulating layer provided on the magnetic substrate and having and lower coil conductors embedded therein, the upper and lower coil conductors being spaced apart from each other in a direction away from the magnetic substrate,
wherein a chamfered surface is provided on both sides of a lower surface of at least one of the upper and lower coil conductors.

6. The coil component of claim 5, wherein an upper surface of at least one of the upper and lower coil conductors has a convex shape.

7. The coil component of claim 5, wherein a width of an upper surface of at least one of the upper and lower coil conductors is greater than that of the lower surface thereof.

8. The coil component of claim 5, wherein the insulating layer includes:
a first insulating layer serving as abase layer of the lower coil conductors;
a second insulating layer covering the lower coil conductors and serving as a base layer of the upper coil conductors; and
a third insulating layer covering the upper coil conductors.
